(19) United States
(12) Patent Application Publication
(10) Pub. No.: US 2015/0145392 A1
(43) Pub. Date: May 28, 2015

(54) Folding Appliance Pedestal

(71) Applicant: Naumaan Khan, Cedar Hill, TX (US)

(72) Inventor: Naumaan Khan, Cedar Hill, TX (US)

(21) Appl. No.: 14/092,897

(22) Filed: Nov. 27, 2013

(51) Int. Cl. A47B 91/00; F16M 13/00; D06F 39/00; A47B 88/04; D06F 58/04; D06F 57/08; F16M 11/00; A47B 97/00

(52) U.S. Cl. CPC A47B 91/005; F16M 11/00; F16M 13/00; A47B 97/00; A47B 88/04; D06F 58/04; D06F 57/08; D06F 39/001
USPC 312/237; 248/678; 248/558; 312/258

(57) ABSTRACT

Different embodiments of a Folding Appliance Pedestal are disclosed. The most differentiating feature of the current invention disclosure is that it collapses for easy shipping. The collapsible feature of the current invention and its many embodiments are achieved by the used of hinges, rivets, and welded rings. In addition, a few of the embodiments can be used as a drying pedestal with the installation of the pedestal-to-dryer adapter.

### TECHNICAL FIELD OF THE DISCLOSURE

The present disclosure relates generally to pedestals on which appliances such as clothing washers and dryers sit.

### BACKGROUND OF THE DISCLOSURE

Users of automatic dryers have always been front-loading, in that a user opens a door in the front of the dryer to place recently washed and still wet clothing into the machine. Until recently, washing machines were top-loading, as their construction requires a rotating tub that is difficult to build with a horizontal axis.

Recently, front-loading washing machines have entered the market in which the rotating tub is oriented horizontally. Because a user must now bend over to reach inside both the washer and dryer, appliance manufacturers are selling them with a pedestal on which they sit, raising the opening in the appliance to a more comfortable level for the user. As an added feature, these pedestals often include drawers in which soap and other items can be stored.

Owners of washers and dryers that were purchased without pedestals often desire to purchase and install third-party pedestals under their appliances. Because the pedestals are bulky, heavy, and not easily shipped, procurement of pedestals entails expensive shipping costs or relegates a would-be pedestal purchaser to sellers close to home.

Appliance manufacturers appear to be more concerned with the appliances than the pedestals, and thus pedestals are heavy, with an inflexible design. Those who sell pedestals must also struggle with the space that these pedestals require while in storage.

The appliance market needs easily shipped, assembled, and installed pedestals.

### SUMMARY OF THE DISCLOSURE

The present disclosure provides a folding appliance pedestal. The pedestal is constructed so it collapses and is easily shipped. Several embodiments are provided, with an alternate construction including a drawer and a pedestal-to-dryer adapter.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which the drawings show several embodiments:

FIG. 1 depicts an embodiment of a folding appliance pedestal using a pin-hinge system.

FIG. 2 depicts the embodiment shown in FIG. 1 showing the stabilizing bars and additional detachable side panels.

FIG. 3 depicts an embodiment of a folding appliance pedestal using welded rings on the side steel panels to act as hinges.

FIG. 4 depicts an embodiment of a folding appliance pedestal using pin-and-lock system and riveted metal L-shape plates.

FIG. 5 depicts the embodiment shown in FIG. 4 with the attachment of a metal panel on the top of the folding appliance pedestal.

FIG. 6 depicts an embodiment of a folding appliance pedestal using a stabilizing subframe with rivets.

FIG. 7 depicts the stabilizing subframe shown in FIG. 6.

FIG. 8 depicts the rivet used in FIG. 7.

FIG. 9 depicts an embodiment of a folding appliance pedestal using rivets and pivoting side panels.

FIG. 10 depicts a partially unfolded embodiment shown in FIG. 9.

FIG. 11 depicts an embodiment of a folding appliance pedestal using rivets and metal braces for stability.

FIG. 12 depicts the unfolding of the side frames of the embodiment shown in FIG. 11.

FIG. 13 depicts the unfolding of the side panels of the embodiment shown in FIG. 11.

FIG. 14 depicts an embodiment of a folding appliance pedestal using rivets and roller bearing weld-on hinges.

FIG. 15 depicts the embodiment shown in FIG. 14 with the hinged side panels unfolded.

FIG. 16 depicts the embodiment shown in FIG. 15 with a foldable drawer.

FIG. 17 shows one embodiment of a folding appliance pedestal using center pin-hinges without the metal skirting.

FIG. 18 depicts the folded position of the embodiment shown in FIG. 17.

FIG. 19 depicts the embodiment shown in FIG. 17 with a metal skirting.

FIG. 20 shows an embodiment of a folding appliance pedestal using a pedestal-to-dryer adapter and slotted drawer.

FIG. 21 depicts the pedestal-to-dryer adapter.

FIG. 22 shows a side view of the pedestal-to-dryer adapter.

FIGS. 23A-23D shows optional folding drawer and telescoping clothing hanging pole.

FIG. 24 contains a legend for the drawings.

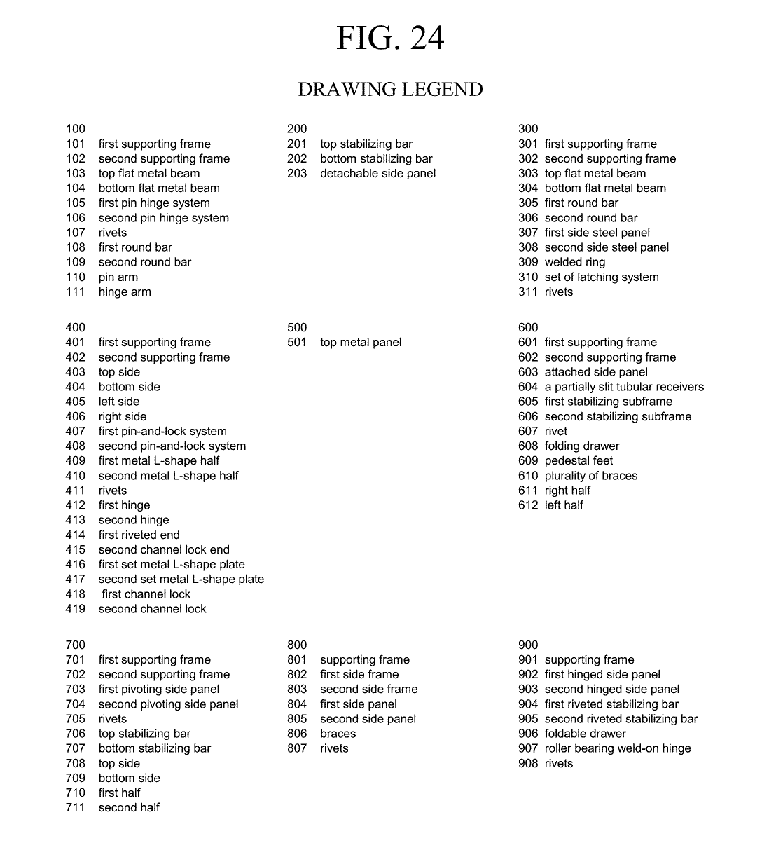

FIG. 25 continuation of FIG. 24.

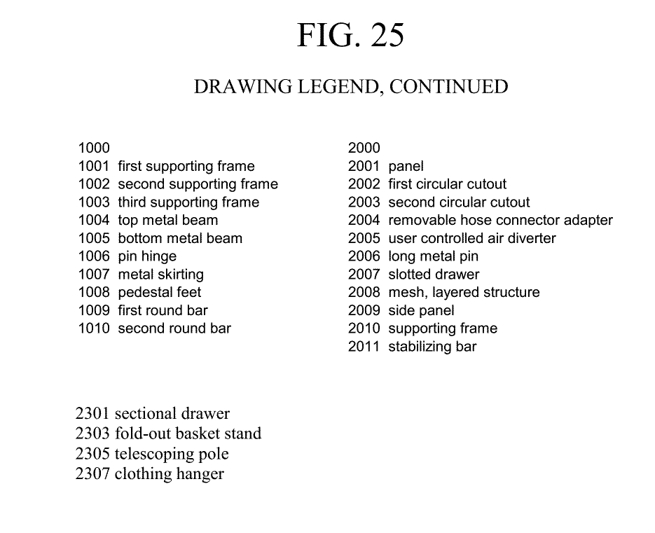

### DETAILED DESCRIPTION OF THE DISCLOSURE

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of a Folding Appliance Pedestal. The specific embodiments discussed herein are, however, merely illustrative of specific ways to make and use the disclosure and do not limit the scope of the disclosure to the specific context disclosed.

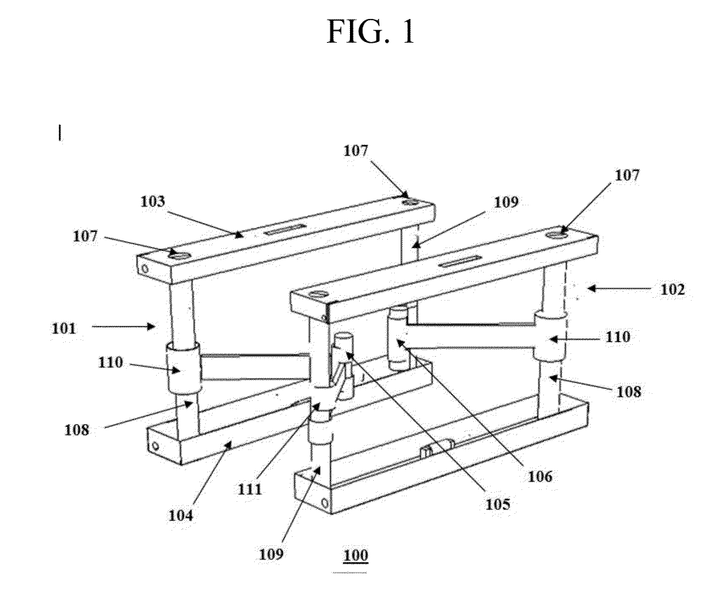

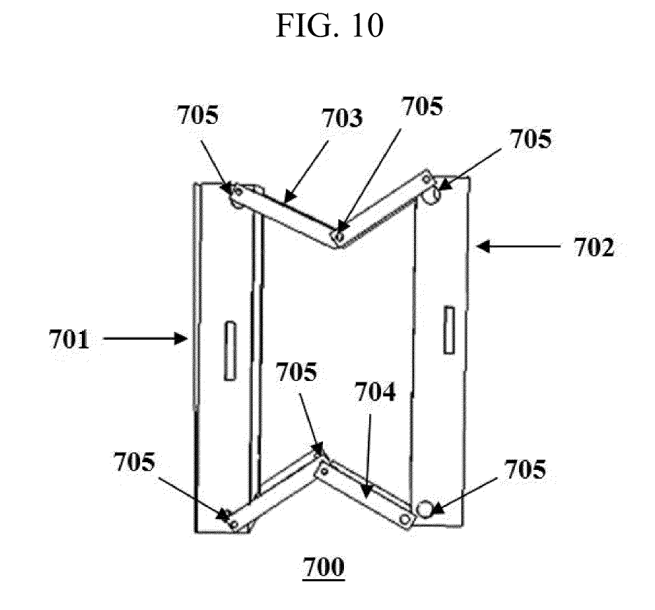

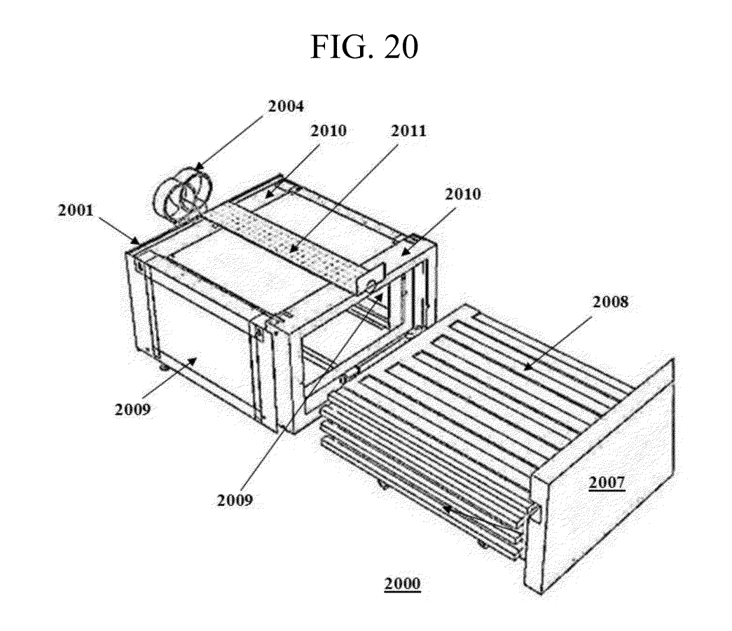

As discussed in the background of the disclosure, the current structural design of a pedestal sold in the market today is a heavy, bulky, and un-collapsible pedestal. On the contrary, the Folding Appliance Pedestal is a collapsible pedestal design primarily made of steel materials, but it is not limited to steel materials. FIGS. 1 through 19 demonstrate different embodiments to make the Folding Appliance Pedestal collapsible. In addition, FIGS. 20 through 22 demonstrate a dual-purpose Folding Appliance Pedestal using a pedestal-to-dryer adapter.

FIG. 1 is an embodiment of a folding appliance pedestal using a pin-hinge system 105, 106. This embodiment has two supporting frames, a first supporting frame 101 and a second supporting frame 102. Each supporting frame 101, 102 has two flat metal beams 103, 104 that make the horizontal sides while the round bars 108, 109 make the vertical side of the supporting frame 101, 102. A plurality of rivets 107 is used to hold the flat metal beams 103, 104 and round bars 108, 109 of the supporting frame 101, 102 together.

The collapsibility feature of this embodiment is achieved by using the pin-hinge system 105, 106. This embodiment uses a first pin-hinge system 105 and a second pin-hinge system 106. Each pin-hinge system comprises a pin arm 110 and a hinge arm 111. One end of the first pin-hinge system 105 is connected to the first round bar 108 of the first supporting frame 101 while the other end is connected to the second round bar 109 of the second supporting frame 102. Oppositely, one end of the second pin-hinge system 106 is connected to the second round bar 109 of the first supporting frame 101 and the other end is connected to the first round bar 108 of the second supporting frame 102.

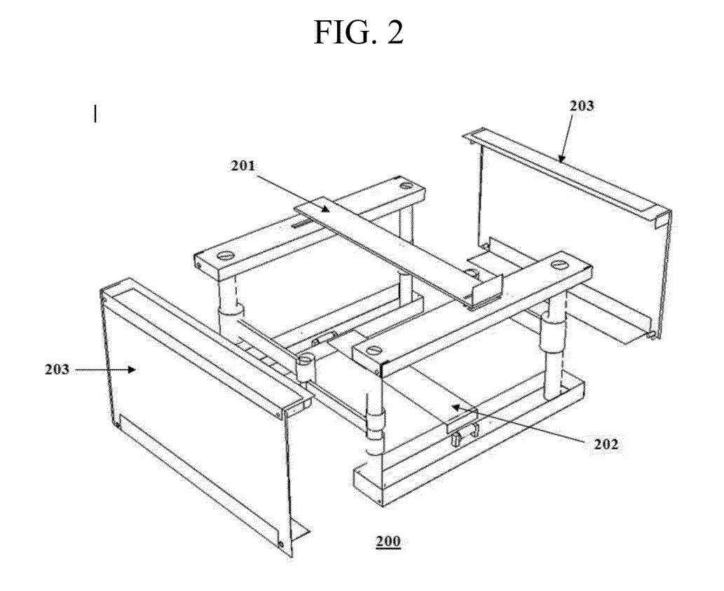

In addition, two stabilizing bars, a top stabilizing bar 201 and a bottom stabilizing bar 202, are used to stabilize this embodiment (the stabilizing bars are not shown on FIG. 1 but shown on FIG. 2).

FIG. 2 shows the embodiment of FIG. 1 further comprising of two detachable side panels 203.

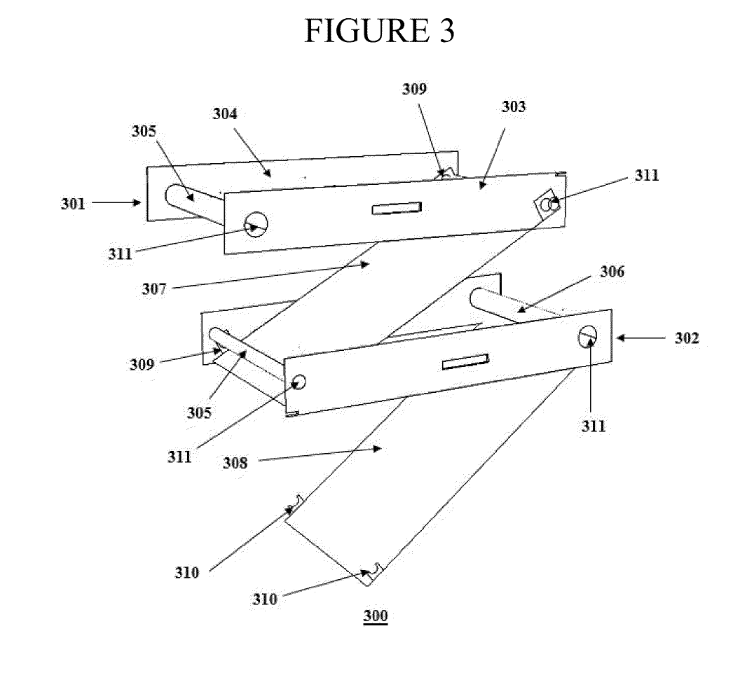

FIG. 3 is another embodiment of a folding appliance pedestal using set of welded rings 309 on the side steel panels 307, 308. The collapsibility feature of this embodiment is achieved by these set of welded rings 309. These set of welded rings 309 enable the side steel panels 307, 308 to pivot around the round bars 305, 306 in a hinge-like manner when folded and unfolded. In addition to the two side steel panels 307, 308, there are two supporting frames, a first supporting frame 301 and a second supporting frame 302. Each supporting frame 301, 302 has two flat metal beams 303, 304 that make the horizontal sides while the round bars 305, 306 make the vertical side of the supporting frame 301, 302. A plurality of rivets 311 is used to hold the flat metal beams 303, 304 and round bars 305, 306 of the supporting frame 301, 302 together. One end of panel 307 connects the two supporting frames 301 302. However, panel 308 is connected only to frame 302 while folded, but when the structure is unfolded from the closed position shown in FIG. 3 so that it instead is square-shaped, the unattached end of panel 308 is attached to frame 301 by a set of latching system 310 that is used to latch onto the first round bar 305 of the first supporting frame 301 to fully secure this embodiment into a pedestal form.

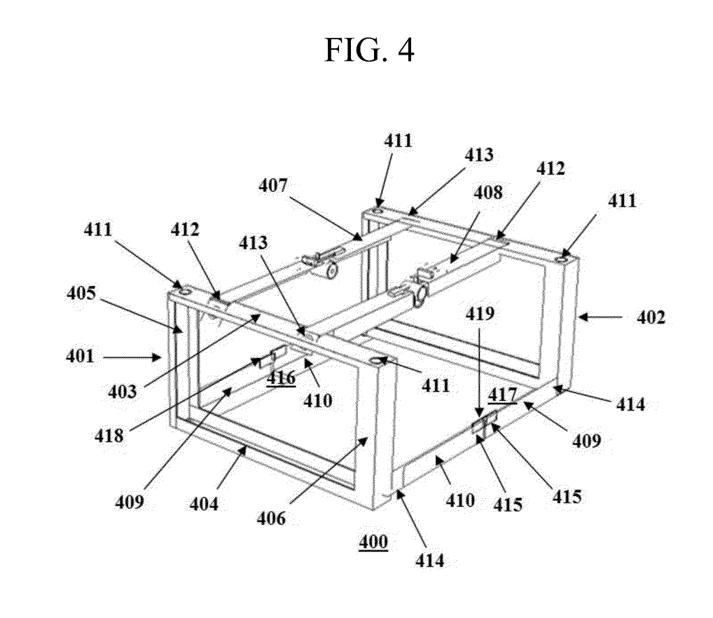

FIG. 4 is another embodiment of a folding appliance pedestal using a pin-and-lock system 407, 408 and metal L-shape plates 416, 417. The two pin-and-lock systems, a first pin-and-lock system 407 and a second pin-and-lock system 408, and the metal L-shape plates, a first set metal L-shape plate 416 and a second set metal L-shape plate 417, enable this embodiment to be collapsible. One end of the first pin-and-lock system 407 is connected to the first hinge 412 located on the top side 403 of the first supporting frame 401 while the other end is connected to the second hinge 413 of the top side 403 of the second supporting frame 402. Conversely, one end of the second pin-and-lock system 408 is connected to the first hinge 412 located on the top side 403 of the second supporting frame 402 while the other end is connected to the second hinge 413 of the top side 403 of the first supporting frame 401. There are two sets of metal L-shape plates, a first set metal L-shape plate 416 and a second set metal L-shape plate 417. Each metal L-shape plates 416, 417 comprises of a first metal L-shape half 409 and a second metal L-shape half 410 where each metal L-shape half 409, 410 has first riveted end 414 and second channel lock end 415. A channel lock 418, 419 (the first set metal L-shape plate 416 uses the first channel lock 418 while the second set metal L-shape plate 417 uses the second channel lock 419) secures the first metal L-shape half 409 to the second metal L-shape half 410 when the pedestal is fully unfolded.

One end of the first set metal L-shape plate 416 is attached to the corner created by joining the left side 405 and bottom side 404 of the first supporting frame 401 using rivets 411, while the other end is attached to the corner created by joining the right side 406 and bottom side 404 of the second supporting frame 402 using rivets 411. Conversely, one end of the second set metal L-shape plate 417 is attached to the corner created by joining the left side 405 and bottom side 404 of the second supporting frame 402 using rivets 411, while the other end is attached to the corner created by joining the right side 406 and bottom side 404 of the first supporting frame 401 using rivets 411.

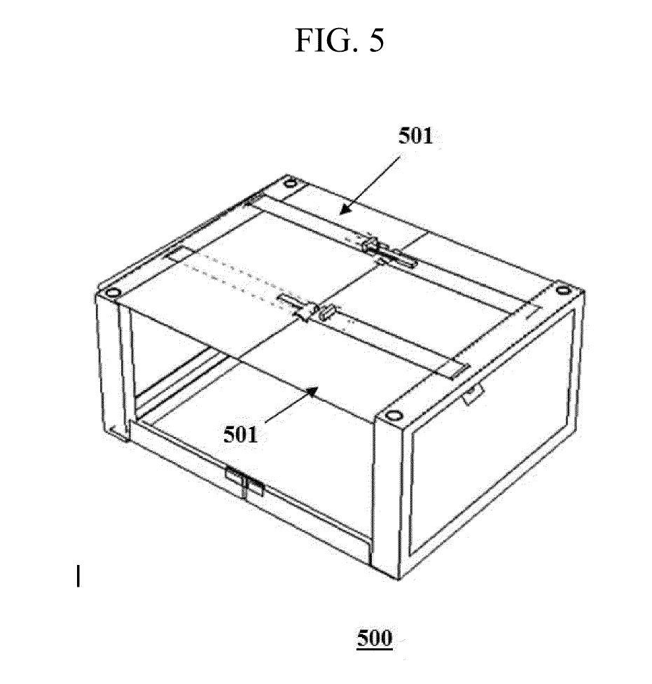

FIG. 5 is the embodiment of FIG. 4, further comprising of a top metal frame that is attached in between the first supporting frame and the second supporting frame.

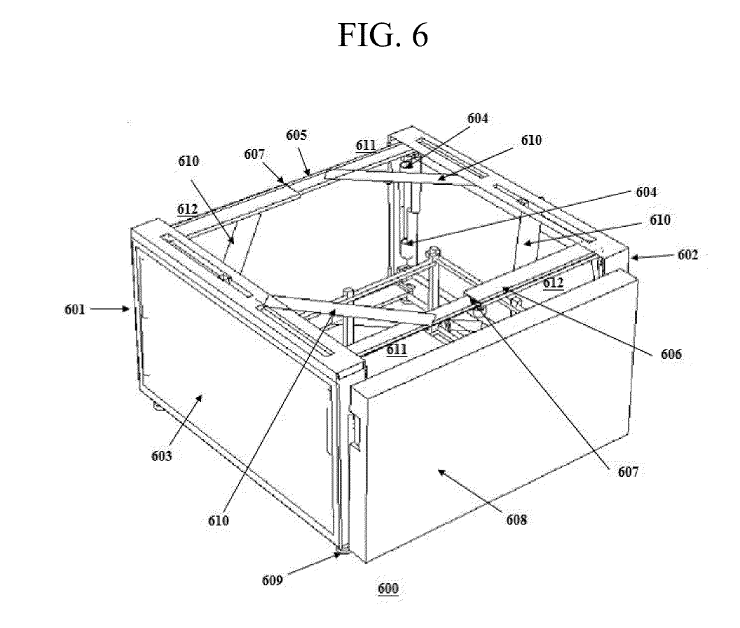

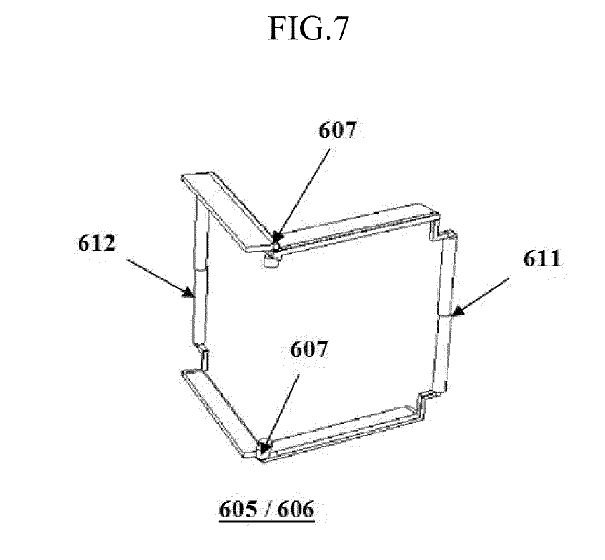

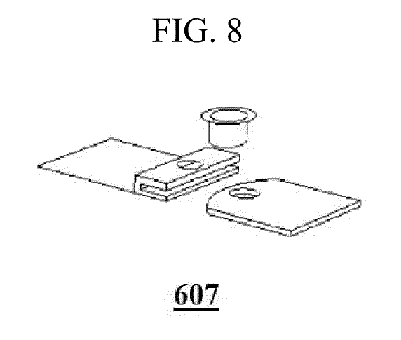

FIG. 6 is another embodiment of a folding appliance pedestal using rivets 607. This embodiment has two supporting frames, first supporting frame 601 and second supporting frame 602, having an attached side panel 603. These two supporting frames are joined by two stabilizing subframes, a first stabilizing subframe 605 and a second stabilizing subframe 606. Each stabilizing subframe 605, 606 pivots about its center to make this embodiment collapsible. In its center are at least two rivets 607 joining the right half 611 and the left half 612 of the stabilizing subframe 605, 606. FIG. 7 and FIG. 8 show the stabilizing subframe 605, 606 and a close-up look of a rivet 607. In addition, each stabilizing subframe 605, 606 is attached to each of the vertical sides of the supporting frames 601, 602 by snapping the vertical sides of the stabilizing subframe 605, 606 into the partially slit tubular receivers 604 found on each of the inner vertical sides of the supporting frames 601, 602. This embodiment is further stabilized by a plurality of braces 610 that are attached diagonally on each corner of the top and bottom horizontal surfaces that are created by adjoining the supporting frames to the stabilizing subframes as shown in FIG. 6. Furthermore, there are at least four pedestal feet 609 on the underside of this embodiment. Also, an optional folding drawer 608 is slid inside this embodiment as desired.

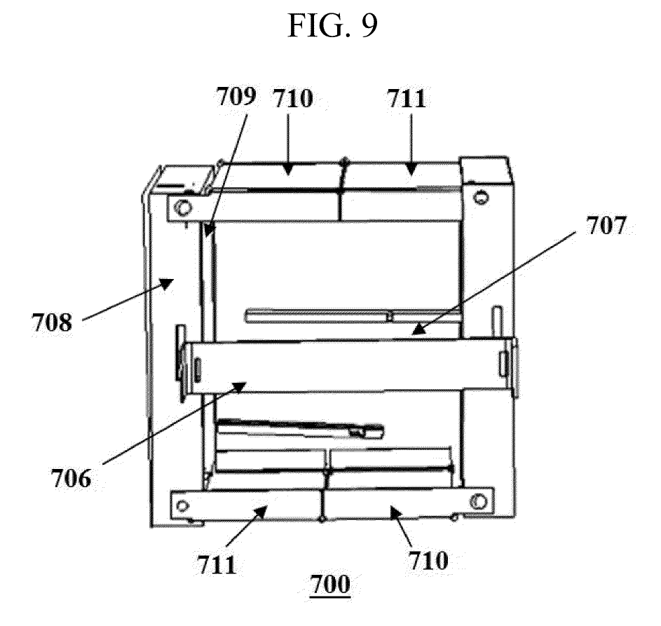

FIG. 9 is another embodiment of a folding appliance pedestal using rivets 705. There are two supporting frames, a first supporting frame 701 and a second supporting frame 702. These two supporting frames 701, 702 are joined by two pivoting side panels, a first pivoting side panel 703 and a second pivoting side panel 704. Each pivoting side panel 703, 704 consists of a first half 710 and a second half 711 joined by at least two rivets 705 in the middle. A plurality of rivets 705 fasten the top 708 and bottom 709 side corners of each supporting frames 701, 702 onto each corner of the pivoting side panels 703, 704. The collapsibility of this embodiment is made possible by the used of rivets 705. Figure shows a partially unfolded embodiment. This embodiment is further stabilized by a top stabilizing bar 706 and a bottom stabilizing bar 707.

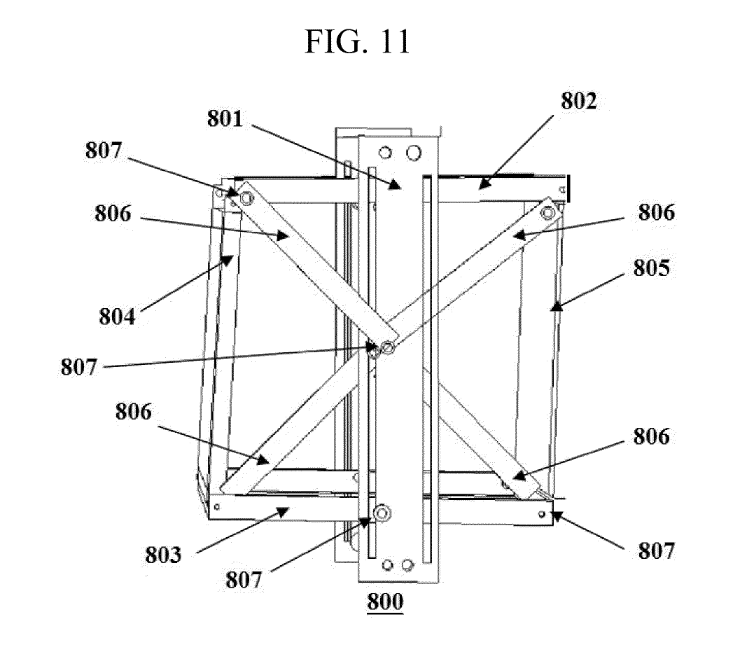

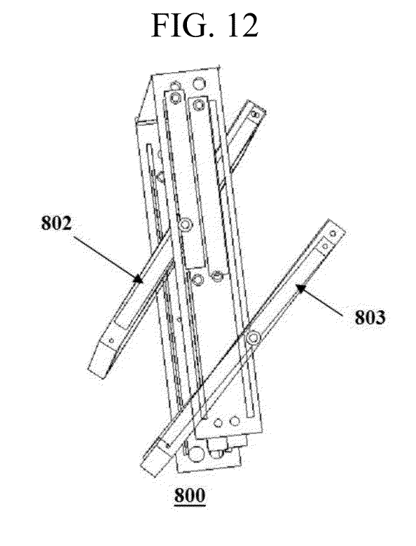

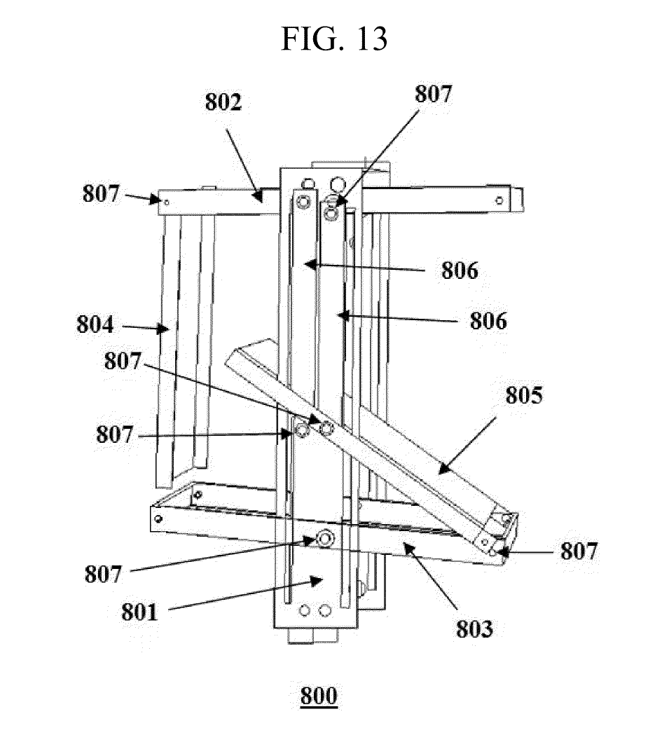

FIG. 11 is another embodiment of a folding appliance pedestal using rivets 807. The supporting frame 801 is a center U-shape metal frame comprising of a first side frame 802, a second side frame 803, a first side panel 804, and a second side panel 805. From its folding position, see FIG. 12, the first side frame 802 and the second side frame 803 are flipped out of the center U-shape metal frame and slid horizontally away from each other until both side frames 802, 803 reach the end of the inside inner track of the supporting frame 801. As shown in FIG. 13, the first side panel 804 and the second 805 side panel are then popped out of the corresponding side frames 802, 803, one at a time. One end of the first side panel 804 is riveted to the corner of the first side frame 802 while the other end is pulled out towards the corner of the second side frame 803 and snapped in place. Similarly, one end of the second side panel 805 is riveted to the corner of the second side frame 803 while the other end is pulled out towards the corner of the first side frame 802 and snapped in place. A plurality of braces 806 is installed for further stability as shown on FIG. 11.

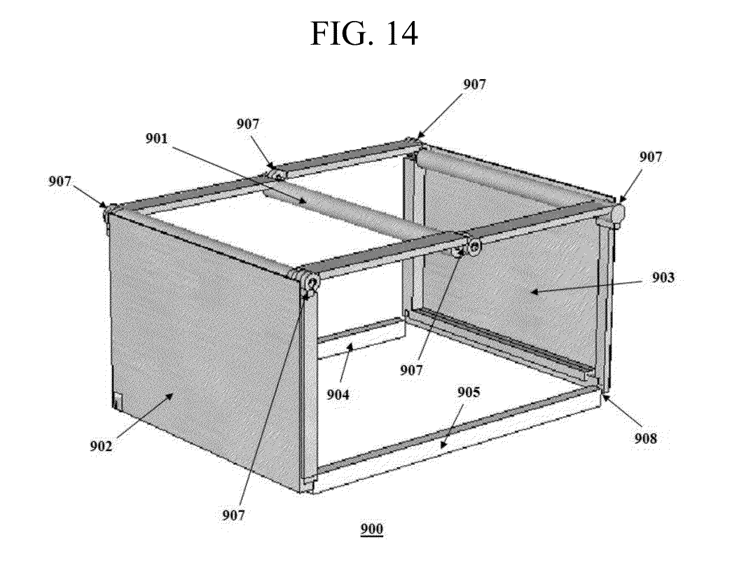

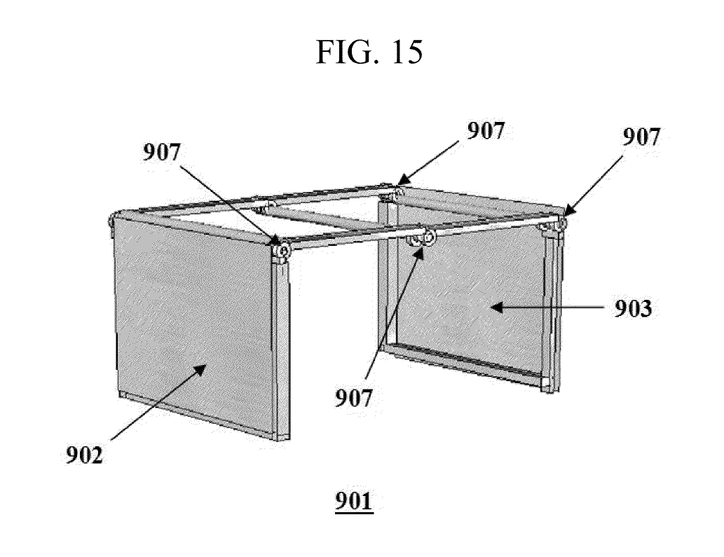

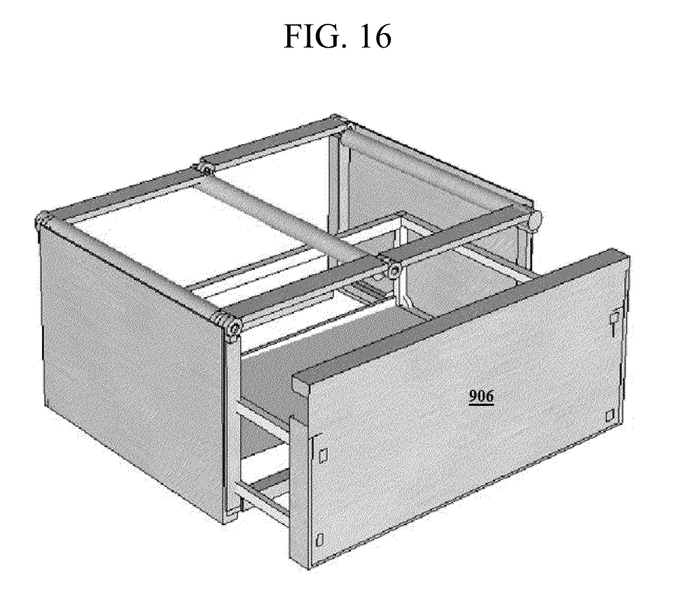

FIG. 14 is an embodiment of a folding appliance pedestal using rivets 908 and roller-bearing weld-on hinges 907. A supporting frame 901 comprises of a first hinged side panel 902 and a second hinged side panel 903. These hinged side panels 902, 903 use roller bearing weld-on hinges 907 to make this embodiment collapsible. From its folded position, the two hinged side panels 902, 903 are unfolded by dropping each hinged side panel 902, 903 down to a vertical position as shown in FIG. 15. The first riveted stabilizing bar 904 is swung away from the first hinged side panel 902 and snapped in place to the bottom corner of the second hinged side panel 903. Similarly, the second riveted stabilizing bar 905 is swung away from the second hinged side panel 903 and snapped in place to the bottom corner of the first hinged side panel 902 as shown in FIG. 14. A foldable drawer 906 is slid inside this embodiment as desired as shown in FIG. 16.

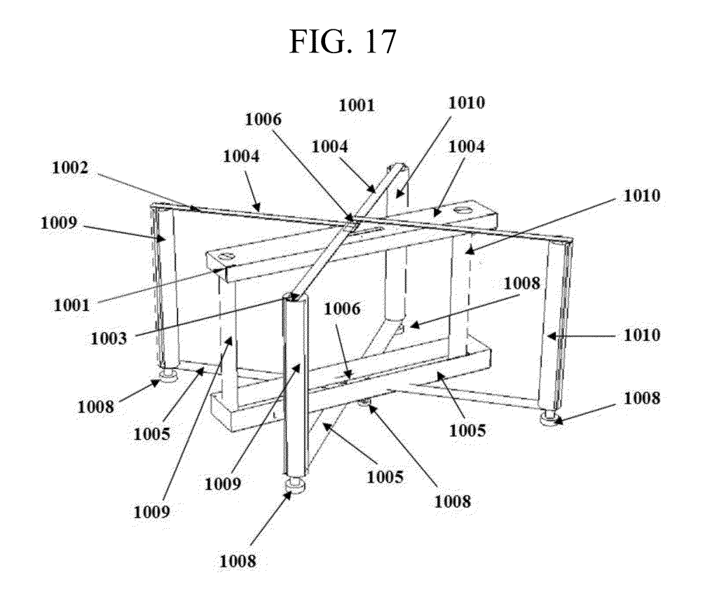

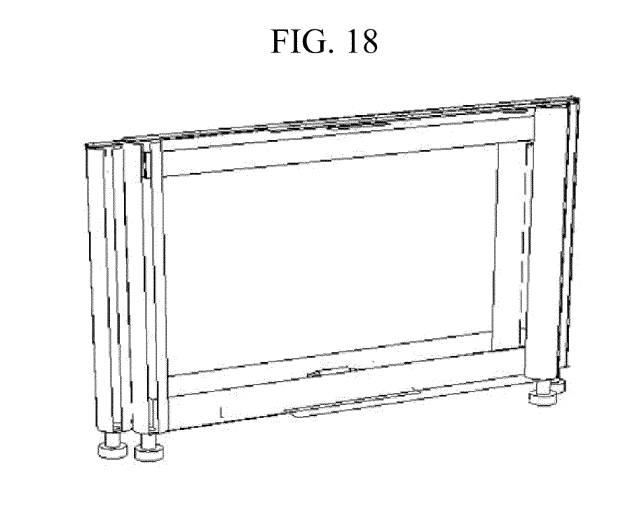

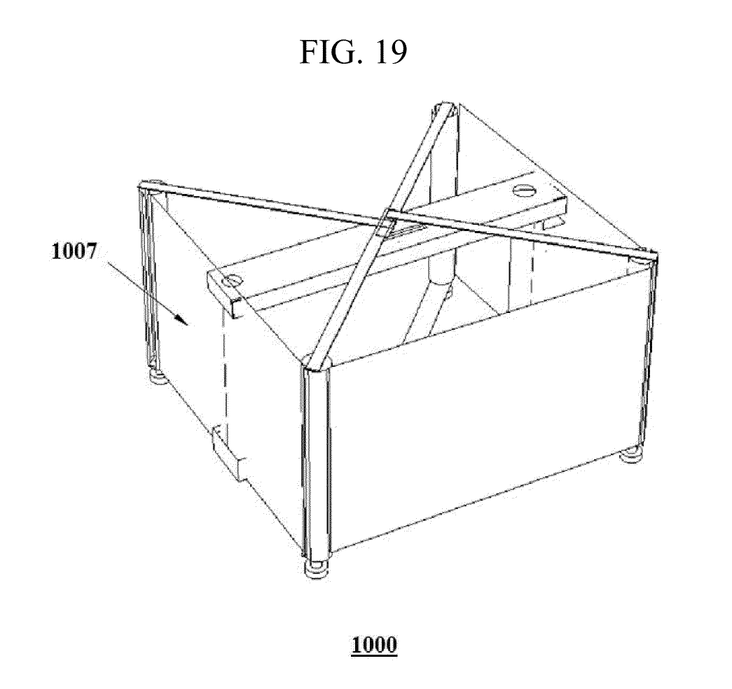

FIG. 17 is an embodiment of a folding appliance pedestal using pin-hinges 1006. There is a pin-hinge 1006 in the middle, center top and a pin-hinge 1006 in the middle, center bottom of this embodiment. These pin-hinges 1006 hold the supporting frames 1001, 1002, 1003 together while allowing them to pivot to either folded, see FIG. 18, or unfolded positions, see FIGS. 17 and 19. There are three supporting frames: a first supporting frame 1001, a second supporting frame 1002, and a third supporting frame 1003. Two metal beams, a top metal beam 1004 and a bottom metal beam 1005, and two round bars, a first round bar 1009 and a second round bar 1010, define the horizontal sides and vertical sides of said pedestal, respectively. When this embodiment is in unfolded position, a metal skirting 1007 is wrapped around the three sides of said pedestal, leaving an opened side for a drawer to slide in, if desired. Also, there are at least four pedestal feet 1008 in the bottom corners of second supporting frame 1002 and third supporting frame 1003.

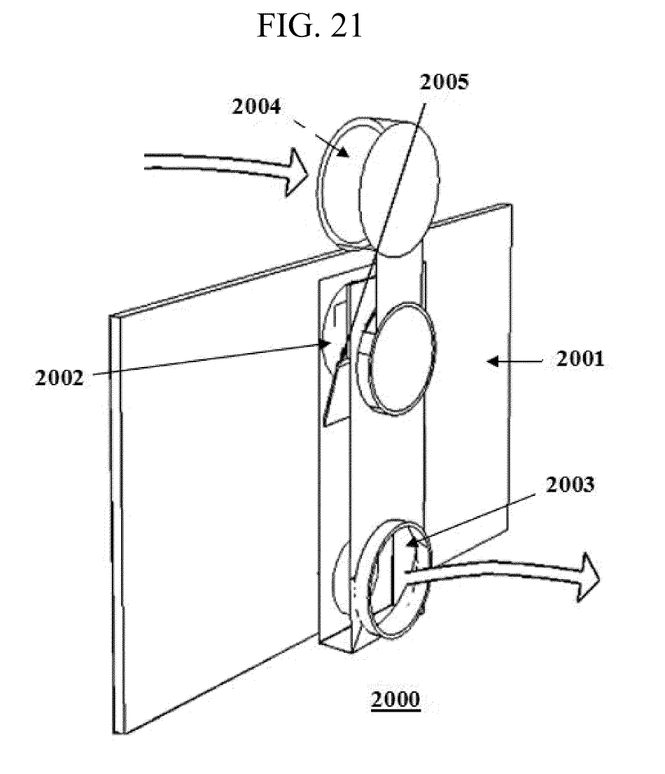

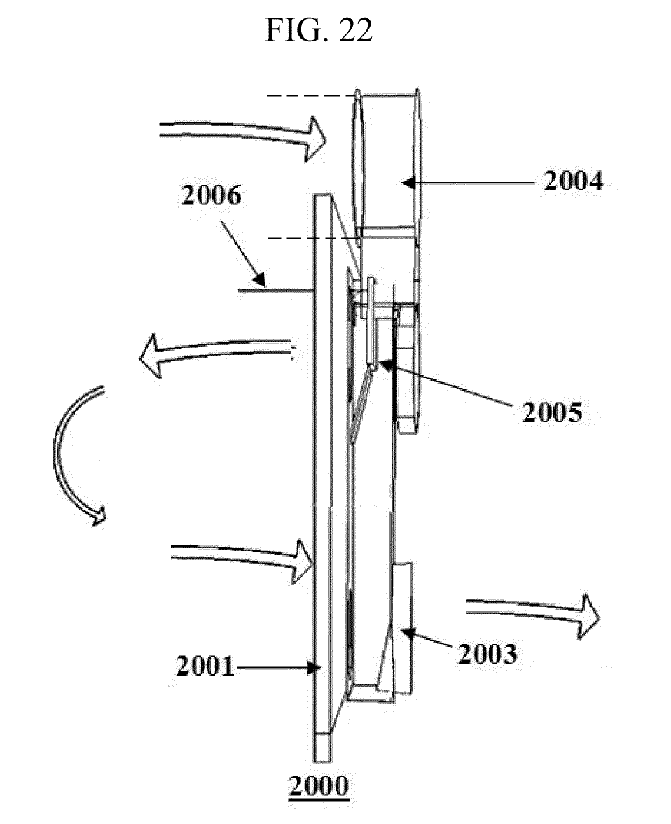

FIG. 20 depicts a dual use embodiment of a folding appliance pedestal. This embodiment is both a pedestal and a dryer. It has at least two supporting frames 2010 wherein said supporting frames 2010 are joined by a plurality of hinges and rivets, at least two side panels 2009 are attached, at least one stabilizing bar 2011, a drawer is slid in the front opening, and a pedestal-to-dryer adapter is installed in the rear. This particular embodiment uses a pedestal-to-dryer adapter, as shown in FIGS. 21 and 22, having a panel 2001 with a first circular cutout 2002, a second circular cutout 2003, a removable hose connector adapter 2004, and a user controlled air diverter 2005 wherein said diverter 2005 is controlled by a long metal pin 2006 that traverses the length of said pedestal. A slotted drawer 2007 having a meshed, layered structure 2008 is used in this particular embodiment as well.

As show in FIG. 22, airflow from a dryer enters the adaptor through the hose connector adapter 2004, and then either back out through second circular cutout 2003, or is sent through the pedestal dryer when the flap of the dryer diverter 2005 when the pin 2006 is in the open position (as shown in FIG. 22).

Thus, the drying capability of this folding appliance pedestal is achieved by connecting the hose coming out of the dryer and into the removable hose connector adapter 2004. The air then comes out of the dryer and into the inside of the removable hose connector adapter 2004. Depending on whether the user has depressed the long metal pin 2006 inward or not, the air either enters the pedestal and out to the second circular cutout 2003 or goes directly out to the second circular cutout and never enters the pedestal.

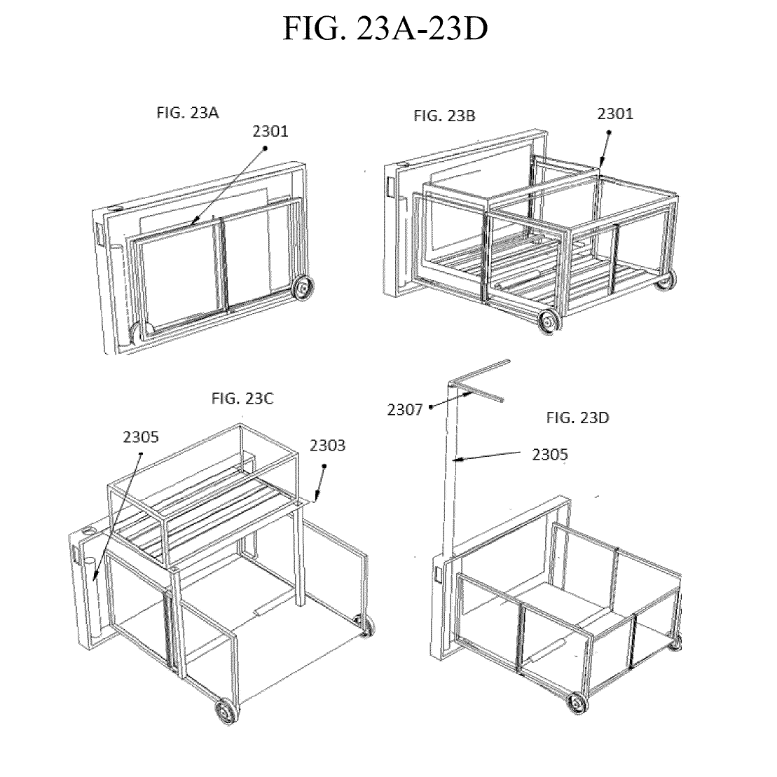

FIG. 23A-23D shows an embodiment of a pedestal drawer with optional components, including a portable folding configuration (FIG. 23A, 23B), which can include sectional drawers 2301 (FIG. 23B-23D), fold-out basket stands 2303 (FIG. 23C), and telescoping pole 2305 (FIG. 23D) which holds a clothes hanger 2307.

What is claimed is:

1. A folding appliance pedestal of a rectangular polyhedron shape comprising of supporting frames wherein said supporting frames are joined by a plurality of hinges, rivets, and welded rings and are stabilized by at least one stabilizing bar.

2. The embodiment of claim 1 comprising:
a) A first supporting frame and a second supporting frame wherein each said supporting frame having a top flat metal beam and a bottom flat metal beam connected by a first round bar and a second round bar;
b) A first pin-hinge system and a second pin-hinge system wherein each said pin-hinge system comprises of a pin arm and a hinge arm wherein said pin arm having a first end attached to said first round bar and a second end attached to a second end of said hinge arm and a first end of said hinge arm is attached to said second round bar of said second supporting frame;
c) A top stabilizing bar having a first end and a second end wherein said first end is attached to said top flat metal beam of said first supporting frame and said second end is attached to said top flat metal beam of said second supporting frame; and
d) A bottom stabilizing bar having a first end and a second end wherein said first end is attached to said bottom flat metal beam of said first supporting frame and said second end is attached to said bottom flat metal beam of said second supporting frame.

3. The embodiment of claim 1 comprising:
a) A first supporting frame and a second supporting frame, wherein each said supporting frame having a top flat metal beam and a bottom flat metal beam connected by a first round bar and a second round bar using a plurality of rivets;
b) A first side steel panel having a first end and a second end and said first end is attached to said second round bar of said first supporting frame by a first set of welded rings and said second end is attached to said first round bar of said second supporting frame by a second set of welded rings;
c) A second side steel panel having a first end and a second end and said first end is attached to said second round bar of said second supporting frame by a fourth set of welded rings and said second end is attached to said first round bar of said first supporting frame by a set of latching system.

4. The embodiment of claim 1 comprising:
a) A first supporting frame and a second supporting frame wherein each said supporting frame is a one piece metal square frame having a top side, a bottom side, a left side, and a right side, said top side having a first hinge and a second hinge;
b) A first pin-and-lock system having a first end and a second end wherein said first end is attached to said first hinge on said top side of said first supporting frame, said second end is attached to said second hinge on said top side of said second supporting frame;
c) A second pin-and-lock system having a first end and a second end wherein said first end is attached to said first hinge on said top side of said second supporting frame, said second end is attached to said second hinge on said top side of said first supporting frame;
d) A first set metal L-shape plate having a first metal L-shape half and a second metal L-shape half wherein said first metal L-shape half having a first riveted end and a second channel lock end, said riveted end is attached to a corner between said bottom side and said left side of said first supporting frame using rivets, said second channel lock end is attached to said second metal L-shape half using a first channel lock; wherein said second metal L-shape half having a first riveted end and a second channel lock end, said riveted end is attached to a corner between said bottom side and said right side of said second supporting frame using rivets, said second channel lock end is attached to said second channel lock end of first metal L-shape half using first channel lock;
e) A second set metal L-shape plate having a first metal L-shape half and a second metal L-shape half wherein said first metal L-shape half having a first riveted end and a second channel lock end, said riveted end is attached to a corner between said bottom side and said left side of said second supporting frame using rivets, said second channel lock end is attached to said second metal L-shape half using a second channel lock; wherein said second metal L-shape half having a first riveted end and a second channel lock end, said riveted end is attached to a corner between said bottom side and said right side of said first supporting frame using rivets, second channel lock end is attached to second channel lock end of first metal L-shape half using second channel lock.

5. The embodiment of claim 1 comprising:
a) A first supporting frame and a second supporting frame wherein each said supporting frame is a one-piece metal square frame having an attached side panel and at least two partially slit tubular receivers on the inner vertical sides of said supporting frame;
b) A first stabilizing subframe having a left half and a right half joined by at least two rivets, said right half is snapped into said partially slit tubular receivers found on the inner vertical sides of said second supporting frame, said left half is snapped into said partially slit tubular receivers found on the inner vertical sides of said first supporting frame;
c) A second stabilizing subframe having a left half and a right half joined by at least two rivets, said right half is snapped into said partially slit tubular receivers found on the inner vertical sides of said first supporting frame, said left half is snapped into said partially slit tubular receivers found on the inner vertical sides of said second supporting frame;
d) A plurality of braces is attached diagonally on each corner of a top and bottom horizontal surface created by adjoining the supporting frames to the stabilizing subframes.

6. The embodiment of claim 1 comprising:
a) A first supporting frame and a second supporting frame wherein each said supporting frame is a one piece metal square frame having a top side and a bottom side;
b) A first pivoting side panel and a second pivoting side panel wherein each side panel has a first half and a second half, said halves are fastened in the middle by at least two rivets, and each corner of said pivoting side panel is fastened using rivets to said supporting frames to form a side of this embodiment;
c) A top stabilizing bar having a first end and a second end wherein said first end is attached in the middle of said top side of said first supporting frame, and said second end is attached in the middle of said top side of said second supporting frame; and
d) A bottom stabilizing bar having a first end and a second end wherein said first end is attached in the middle of said bottom side of said first supporting frame, and said second end is attached in the middle of said bottom side of said second supporting frame.

7. The embodiment of claim 1 comprising:
a) A supporting frame having a plurality of rivets, a center U-shape metal frame, a first side frame, a second side frame, a first side panel, and a second side panel; wherein said first side frame and said second side frame are flipped out of the said center U-shape metal frame and slid away from each other until locked in place horizontally, said first side panel is popped out of said first side frame and is locked in place in the corner of said second side frame, said second side panel is popped out of said second side frame and is locked in place in the corner of said first side frame; and
b) A plurality of braces is attached from said center U-shape metal frame to corners created by adjoining said side frames and said side panels.

8. The embodiment of claim 1 comprising a supporting frame having a first hinged side panel, a second hinged side panel, a first riveted stabilizing bar, and a second riveted stabilizing bar wherein said hinged side panels are dropped down from their folding position and said riveted stabilizing side bars are swung away from a stowed position behind said hinged side panels to a perpendicular position between said hinged side panels.

9. The embodiment of claim 1 comprising a first supporting frame, a second supporting frame, and a third supporting frame, wherein each said supporting frame having a top flat metal beam and a bottom flat metal beam that are connected by a first round bar and a second round bar, and said supporting frames are joined together at the center of their respective said top flat metal beam, and said bottom flat metal beam by a pair of hinges; and a metal skirting wrapped around from said second round bar of said third supporting frame to said first round bar of said second supporting frame.

10. The embodiment of claim 2 further comprising a detachable side panel covering each side of said pin-hinge system.

11. The embodiment of claim 4 further comprising a top metal panel between said first supporting frame and said second supporting frame.

12. The embodiment of claim 5 further comprising a folding drawer.

13. The embodiment of claim 8 further comprising a foldable drawer wherein said foldable drawer is slid inside said embodiment.

14. A folding appliance pedestal of a rectangular polyhedron shape comprising:
a) At least two supporting frames wherein said supporting frames are joined by a plurality of hinges and rivets;
b) At least two side panels are attached on said pedestal;
c) At least one stabilizing bar is attached between said supporting frames;
d) A drawer is slid inside the front opening of said pedestal; and
e) A pedestal-to-dryer adapter is installed in the rear of said pedestal which directs the dryer's exhaust into said pedestal drawer.

15. A folding appliance as in claim 14, wherein the pedestal-to-dryer adapter comprises a panel with a first circular cutout, a second circular cutout, a hose connector adapter, and a diverter wherein said diverter is positioned by a long metal pin traversing the length of said embodiment, such that the pin's position determines whether said dryer's exhaust is diverted into said pedestal drawer, or exits the dryer and does not enter the pedestal drawer.

16. A folding appliance as in claim 15, wherein the pedestal includes a slotted drawer having a meshed, layered structure wherein said slotted drawer is slid inside said embodiment.

17. A folding appliance as shown in claim 14, wherein the drawer is collapsible, and when folded out to its working configuration, creates one or more drawers.

18. A folding appliance as shown in claim 14, wherein the drawer also comprises a clothes hanger mounted on a telescoping mounting rod.
